(19) United States
(12) Patent Application Publication
(10) Pub. No.: US 2022/0327927 A1
(43) Pub. Date: Oct. 13, 2022

(54) VIRTUALIZED ROAD TRAFFIC SIGN GENERATION FOR ENHANCING ROAD SAFETY

(71) Applicant: NEC Laboratories Europe GmbH, Heidelberg (DE)

(72) Inventors: Girma Mamuye Yilma, Heidelberg (DE); Francesco Devoti, Heidelberg (DE); Faqir Zarrar Yousaf, Heidelberg (DE)

(21) Appl. No.: 17/356,636

(22) Filed: Jun. 24, 2021

Related U.S. Application Data
(60) Provisional application No. 63/173,518, filed on Apr. 12, 2021.

(51) Int. Cl. G08G 1/09; G08G 1/0967; G08G 1/01; H04W 4/44

(52) U.S. Cl. CPC G08G 1/094; G08G 1/096733; G08G 1/096783; G08G 1/0133; H04W 4/44

(57) ABSTRACT

Systems and methods are described for enhancing road safety via on-demand virtualized road traffic sign generation. A method for generating information for display in a target object (TO) includes: receiving at least one notification message from one or more TOs; generating a situation map for a relevance zone (RZ) based on information in the at least one notification message; encoding an action matrix in a notification message, wherein the action matrix is derived based on the situation map; and transmitting the notification message to the TOs in the RZ. A system includes one or more road side units (RSUs) configured to establish a wireless communication channel with one or more TOs; and a mobile edge computing (MEC) system that includes one or more processors and is configured to implement a virtualized road traffic sign generation service.

### CROSS-REFERENCE TO PRIOR APPLICATION

Priority is claimed to U.S. Provisional Application No. 63/173,518, filed on Apr. 12, 2021, the entire disclosure of which is hereby incorporated by reference herein.

### FIELD

The present disclosure relates to a method and systems for automated traffic control systems and, in particular, for determining and generating virtualized traffic signs for enhancing traffic and road safety.

### BACKGROUND

According to current infrastructure, road traffic signs are fixed in given physical locations, which results in a static traffic signs deployment at least during extended periods of time because the physical intervention of workers and/or special vehicles is usually required to adapt the traffic signs infrastructure in response to changing conditions (e.g., road works, changing traffic situation, road/driving conditions, etc.). Moreover, current digital map (navigation) services available for vehicles are only capable of showing existing road traffic signs, which are not automatically updated along with changes to the environment or traffic conditions.

To enforce temporal traffic signs infrastructure changes, for example, in the case of temporary construction or road works, trucks with posted road signs are often used to signal the construction and alert drivers. In the case of closed roads or deviations, new signs are often posted alongside the existing road traffic signs already present, thus increasing the amount of information that drivers must look at and take into account while driving, and creating the potential for confusion. Drivers usually only see such new signs once already in the proximity of the danger, potentially leading to missing or ignoring the warning in the case of distraction or harsh weather conditions. Also, according to the current traffic signs infrastructure with signage being fixed, it is not possible to adapt signs optimally to the current traffic/road conditions. Moreover, deploying and maintaining road signs is an expensive and time-consuming operation involving coordination between different departments/organizations.

### SUMMARY

In an embodiment, the present disclosure provides a method for generating information for display in a target object (TO). The method includes computer-implemented operations that include: receiving at least one notification message from one or more TOs; generating a situation map for a relevance zone (RZ) based on information in the at least one notification message; encoding an action matrix in a notification message; and transmitting the notification message to the TOs in the RZ. The action matrix is derived based on the situation map.

In another embodiment, the present disclosure provides a system that includes one or more road side units (RSUs) configured to establish a wireless communication channel with one or more TOs; and a mobile edge computing (MEC) system that includes one or more processors and is configured to implement a virtualized road traffic sign generation service that implements the method set forth above.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 schematically illustrates a method and system architecture of a virtualized road traffic sign system, according to an embodiment of the present disclosure;

FIG. 2 schematically illustrates a method and system architecture for a virtualized road traffic sign system, according to an embodiment of the present disclosure, including traffic light information;

FIG. 3 schematically illustrates a method and system architecture for a virtualized road traffic sign system, according to an embodiment of the present disclosure, including different situations and target object displays;

FIG. 4 illustrates a method for creating, disseminating, and removing virtualized road traffic signs, according to an embodiment of the present disclosure;

FIG. 5 illustrates a method for receiving and displaying virtualized road traffic signs, according to an embodiment of the present disclosure;

FIG. 6 illustrates a method for generating a situation map and deriving an action-matrix for a notification message, according to an embodiment of the present disclosure;

FIG. 7 schematically illustrates a functional architecture of a virtualized road traffic signs generator service, according to an embodiment of the present disclosure;

FIG. 8 schematically illustrates a method and system architecture of a distributed virtualized road traffic signs generator service, according to an embodiment of the present disclosure;

FIG. 9 schematically illustrates interactions between a client and server according to an embodiment of the present disclosure;

FIG. 10 is an example of a situation index, according to an embodiment of the present disclosure; and

FIG. 11 is an example of a situation map, according to an embodiment of the present disclosure.

### DETAILED DESCRIPTION

Current road traffic signs/warnings are static, and are updated in a non-real-time fashion with limited information scope. Digital map services on vehicles are also restricted to displaying these static road signs/traffic warnings/information. In contrast, embodiments described in the present disclosure provide a method, system, and computer-readable medium for the dynamic, fine granular, real-time, situation-aware and user-centric generation of virtual road traffic signs (e.g., traffic or environment information, warnings, messages, etc.) that leverage collaborative intelligent mobile edge computing (MEC)/Cloud services to adapt to real-time conditions of the driving environment. According to the embodiments of the present disclosure, the resulting virtual signs may be displayed on a vehicle's navigation system/dashboard.

In an embodiment, the method leverages the ability of modern vehicles to connect to a mobile network. Car manufacturers may use this feature to provide multiple services to the driver and enhance the quality and safety of the driving experience. Vehicles are often now equipped with interactive dashboards and head-up displays (HUD) that allow the driver to monitor the status of the vehicle, control the infotainment system, and many other features. Although navigation systems have the ability of prompting traffic signs according to the vehicle location (e.g., current speed limit), these services exploit digital maps that are not updated in real time. Therefore, the driver might rely on information that does not reflect the current state of the road infrastructure. Advanced Driver Assistance Systems (ADAS) with the ability of reading traffic signs on the road and projecting it on the vehicle's dashboard are increasingly available on modern cars. Those solutions address distractions and improve safety. However, since they are based on the process of reading the signs that are physically and statically located along the route, this technology suffers from the same drawbacks as the physical signage and does not allow any type of override for the signs which would be useful in case of immediate need (for example, in the case of accidents or dangers along the road), but that do not physically exist at the appropriate location.

Embodiments described herein leverage the use of connected vehicles and the fifth generation (5G) and/or beyond 5G networks to help overcome the limitation of current traffic signs deployment by replacing or augmenting (to support legacy vehicles) the physical road signs infrastructure with a virtual one. Connected cars continuously exchange information with a virtualized traffic signs generation service running on the network side, providing the network with a holistic and real-time view of the road/traffic conditions with suitable instructions (e.g., speed recommendations, warning signs, lane suggestion, on-demand traffic light generation, etc.). The service computes the optimal road signs placement according to the available information and informs the vehicles accordingly. Vehicles can then project the current signs on the vehicle's dashboard and/or head-up display, and/or other suitable multimedia device. Embodiments described herein also enable the network to learn optimal road traffic signs and provide a real time optimization of the traffic signs deployment that allows for complete flexibility in automated or semi-automated road traffic management. Moreover, as no physical traffic signs are involved, there is no need for human interaction for installation, operation or maintenance, thereby providing significant savings in operation and capital expenditures.

Hahanov, V., et al., “Cloud-Driven Traffic Monitoring and Control Based on Smart Virtual Infrastructure,” SAE Technical Paper 2017-01-0092, doi:10.4271/2017-01-0092 (2017), which is hereby incorporated by reference herein in its entirety, describe centralized traffic monitoring and control with a smart virtual infrastructure, but does not describe various aspects of its implementation. In contrast, embodiments described herein provide a distributed system that allows for improving the latency of the monitoring and control with an actual implementation that is feasible. Olaverri-Monreal, C., et al., “In-vehicle virtual traffic lights: a graphical user interface,” 7th Iberian Conference on Information Systems and Technologies (CISTI 2012), IEEE (2012), which is hereby incorporated by reference herein in its entirety, describe a method for an in-vehicle virtual traffic lights display while considering a static scenario with fixed road sign deployment. Such a visualization system can be used in embodiments described herein to display the road signs in the vehicles, thereby improving the visualization system to add the real-time adaptation of road sign infrastructure to the in-vehicle signal display functionality.

Embodiments described herein may leverage the capability of connected vehicles and edge network infrastructure to replace road/traffic/speed-limits signs with virtual road/traffic/speed-limits signs virtually projected onto the display system, such as on a vehicle dashboard display and/or head-up display. These signs, which might not be physically installed at the roadside, are projected according to the position of the vehicle and the road/traffic situation in the vicinity of the vehicle at the particular time, and the virtual signs can be updated in real time according to changing road/traffic conditions, unexpected and detected events, time, weather conditions, etc. Different types of road users can also be taken into account according to embodiments of the present disclosure. For example, in the case of a crosswalk for pedestrians, the system can take into account the smartphones of the pedestrians to identify the pedestrian cluster, and regulate the crossing of the pedestrians via the crosswalk. In this case, the system/method will indicate/enforce the vehicle(s) to stop (e.g., auto-breaking) before a particular virtual border. Advanced visualization technologies such as digital light (see Mercedes Benz, “Revolution in headlamp technology: Mercedes shines in HD quality,” Daimler Communications Press Release (Dec. 2, 2016), which is hereby incorporated by reference herein in its entirety) could be activated by the system to even project a beam of light on the road, and/or generate specific sound signals emulating a crosswalk, implying to the pedestrians that it is safe to cross. Vehicles can also coordinate themselves to show collaborated crosswalk signs across multiple lanes in the case of multi-lane roads.

For describing embodiments of the present disclosure, the following terminology is used:

1. Target object (TO): This object (e.g., a vehicle) receives virtualized traffic signs and displays them on a dashboard/navigation system. The TO continuously updates information about itself such as, but not limited to, a type, a current location, a direction, a route-path and/or speed information, preferably with an anonymized identifier, for a given route via specific notification messages, for example, as European Telecommunications Standards Institute (ETSI) Cooperative Intelligent Transport System (C-ITS) Cooperative Awareness Message (CAM) notifications, to the MEC application/service instantiated on the relevant MEC hosts in the infrastructure, which then derives the real-time virtualized road/traffic signs. The TO is also able to receive and process notification messages from the MEC infrastructure, such as ETSI C-ITS Decentralized Environmental Notification Message (DENM) notifications, that carry road/traffic signs/information which can then be displayed on the TOs display system. In an embodiment, a TO might display virtual traffic signs such as a crosswalk with a beam of light in collaboration with other TOs in the case of multi-lane roads.

2. Virtualized road traffic sign generator service (vRTSGS): This is a service preferably running on distributed, but collaborating smart MEC servers to build the virtualized traffic and road signs for different road segments, and disseminate to TOs on the relevant road segments using notification messages, for example, by encoding the virtualized traffic and road signs in the standard ETSI C-ITS DENM messages. 3. Virtualized road traffic signs (VRTS): are road traffic signs generated based on a current condition of the road infrastructure and traffic condition at the edge of the network and disseminated to relevant TOs, for example, as DENM notifications and displayed on some human-machine interface (HMI) such as the navigation system and/or display system (e.g., head-up display) of the TOs.

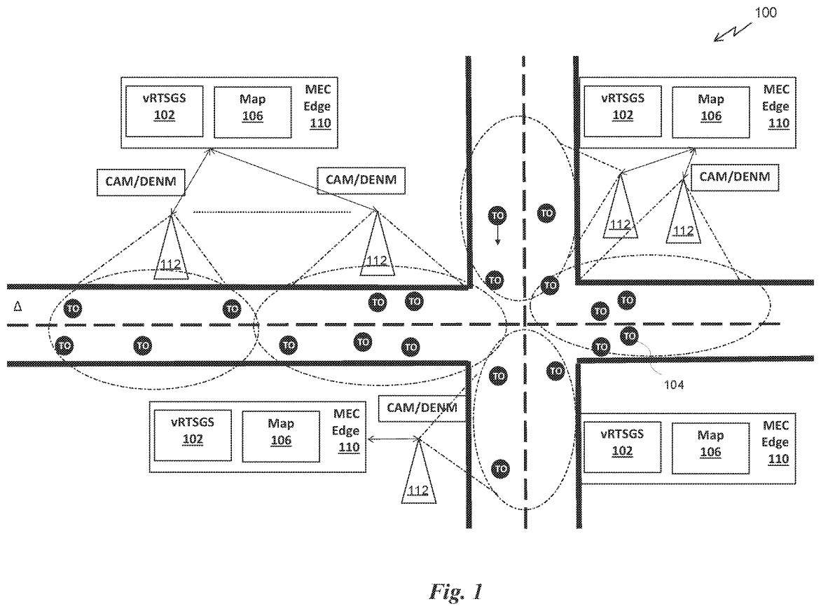

Preferably, the method and system according to embodiments of the present disclosure are orchestrated with an Artificial Intelligence (AI) enabled MEC/edge/cloud service/application, which is also referred to as the vRTSGS or the vRTSGS system, to derive road/traffic/environment condition/situation using the information transmitted by the on-board units (OBU) of the TOs. The OBU collects information from the various sensors (e.g., camera, GPS, temperature) and instruments (e.g., speedometer, fuel gauge) on-board the TO and transmits them towards the edge infrastructure hosting the vRTSGS. For example, the TOs can encode this, and a variety of other, information in an ETSI C-ITS CAM notification and communicate the notification over the mobile network infrastructure, such as over the Uu interfaces and 5G New Radio (5GNR) to the vRTSGS instance instantiated on a MEC system. The vRTSGS instance parses the information in the CAM notifications being periodically received from the TOs on specific road segments, and is able to determine the road/traffic/environment conditions by creating a situation map for the respective road segments, and for the specific TOs as well. The vRTSGS instance then correlates the situation map with the road/traffic policy for the respective road segments in order to derive road/traffic signs/signals that are appropriate to the prevailing situation. A high-level overview of the scenario is illustrated in FIGS. 1-3.

In accordance with a first aspect of the present disclosure, a method is provided for generating information for display in a target object (TO). The method includes computer-implemented operations for: receiving at least one first notification message from one or more TOs; generating a situation map for a relevance zone (RZ) based on information in the at least one first notification message; encoding an action matrix in a second notification message; and transmitting the second notification message to the TOs in the RZ. The action matrix is derived based on the situation map.

In accordance with one embodiment of the first aspect, the at least one first notification message received from the one or more TOs includes a Cooperative Intelligent Transport System (C-ITS) Cooperative Awareness Message (CAM) message.

In accordance with one embodiment of the first aspect, each target object includes an on-board unit (OBU) of a vehicle. The OBU is configured to establish a wireless communication channel with a road side unit (RSU), and the RSU comprises a base station or an access point for a wireless network.

In accordance with one embodiment of the first aspect, the RZ is associated with one or more situation maps of varying scope. The scope of a particular situation map is encoded in a 3-tuple key identifier that includes a RZ identification (RZ_Id), a Direction (Dir), and a TO Identifier (TO_Id).

In accordance with one embodiment of the first aspect, encoding the action matrix in the second notification message includes: deriving a situation matrix based on the situation map; correlating situation codes in the situation matrix with a policy for the RZ; deriving an action matrix based on the situation codes correlated with the policy; and encoding the action codes in the action matrix in the second notification message.

In accordance with one embodiment of the first aspect, the second notification message comprises a C-ITS Decentralized Environmental Notification Message (DENM) notification message.

In accordance with one embodiment of the first aspect, the information included in the at least one first notification message includes at least one of: a type of a particular TO; a position of the particular TO; a speed of the particular TO; or a direction of the particular TO.

In accordance with a second aspect of the present disclosure, a method is provided for displaying information in a target object (TO). The method includes computer-implemented operations for: transmitting at least one first notification message to a service; receiving a second notification message from the service; parsing an action matrix from the second notification message; translating action codes included in the action matrix into display information; and presenting the display information on a display device of the TO. Each first notification message includes information related to the TO.

In accordance with one embodiment of the second aspect, prior to parsing the action matrix from the second notification message from the service, the method further includes operations for: determining that a destination address included in the second notification message is a broadcast address or a unicast address associated with the TO, and parsing the action matrix from the second notification message from the service; or determining that the destination address is a unicast address that is not associated with the TO, and discarding the second notification message from the service.

In accordance with one embodiment of the second aspect, the information included in the at least one first notification message comprises at least one of: a type of the TO; a position of the TO; a speed of the TO; or a direction of the TO.

In accordance with one embodiment of the second aspect, the display information includes an image of a virtualized road/traffic sign. Presenting the display information on the display device of the TO includes displaying the image on a light emitting diode (LED) or organic light emitting diode (OLED) display device of the TO.

In accordance with one embodiment of the second aspect, the display information includes a character string. Presenting the display information on the display device of the TO includes displaying the character string on a light emitting diode (LED) or organic light emitting diode (OLED) display device of the TO.

In accordance with a third aspect of the present disclosure, a system is provided for generating and displaying information in a target object (TO). The system includes: one or more road side units (RSUs) configured to establish a wireless communication channel with one or more TOs; and a mobile edge computing (MEC) system comprising one or more processors and configured to implement a service. The service is configured to: receive at least one first notification message from the one or more TOs, generate a situation map for a relevance zone (RZ) based on information in the at least one first notification message, encode an action matrix in a second notification message, and transmit the second notification message to the TOs in the RZ. The action matrix is derived based on the situation map.

In accordance with one embodiment of the third aspect, encoding the action matrix in the second notification message includes: deriving a situation matrix based on the situation map; correlating situation codes in the situation matrix with a policy for the RZ; deriving an action matrix based on the situation codes correlated with the policy; and encoding the action codes in the action matrix in the second notification message.

In accordance with a fourth aspect of the present disclosure, a tangible, non-transitory computer-readable medium is provided having instructions thereon which, upon being executed by one or more processors, facilitate execution of the method according to the first or second aspect.

In accordance with a fifth aspect of the present disclosure, an apparatus is provided including at least one processor and a memory storing program code. The at least one processor, responsive to executing the program code, is configured to perform operations to facilitate execution of the method according to the first or second aspect.

FIGS. 1-3 schematically illustrates a method and system architecture of a virtualized road traffic sign (VRTS) system 100, according to an embodiment of the present disclosure. As depicted in FIG. 1, a certain section of the road network is being served by a number of vRTSGS instances 102 that are deployed and instantiated in MEC systems 110. The TOs 104 on the road communicate with the respective vRTSGS instances 102 via the Road Side Units (RSUs) 112. In some embodiments, the RSUs 112 can be base stations of the mobile communication infrastructure (e.g., 5GNR, eNodeB, WiFi, etc.), which connects the TOs 104 with the MEC systems 110 where the vRTSGS instances 102 are deployed. The TOs 104 periodically send CAM notifications towards the relevant vRTSGS instance 102 via the RSUs 112 encoding relevant information.

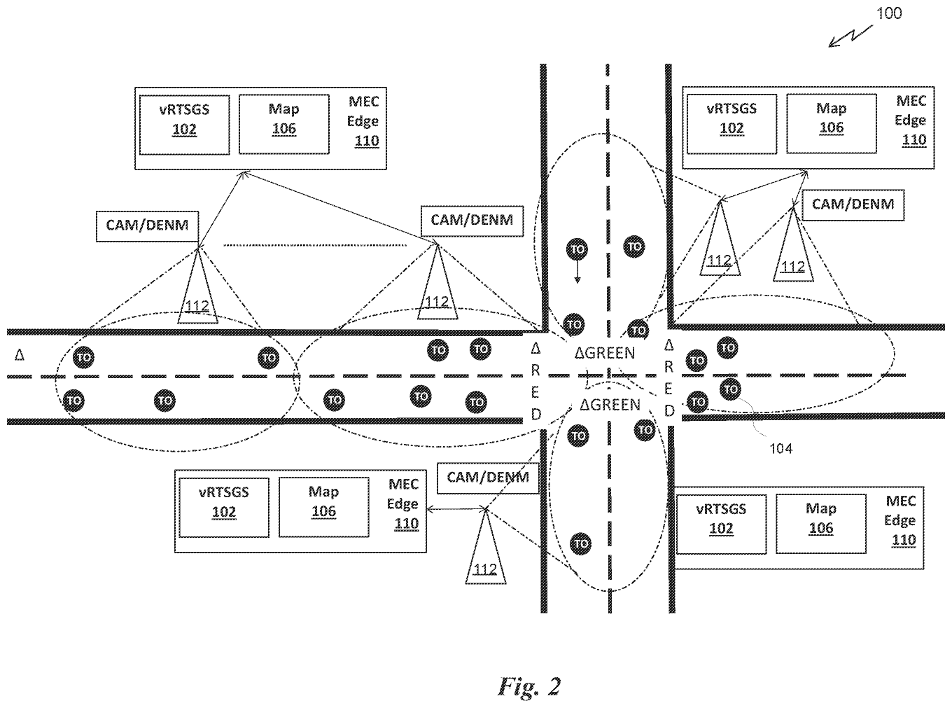

As depicted in FIG. 2, the state of the traffic lights at an intersection is shown with a green light permitting traffic to move vertically and a red light prohibiting traffic from moving horizontally. The state of the traffic lights may be dictated by policy and/or controlled dynamically based on the state of road/traffic/environment situation. In some embodiments, a physical traffic light located in the field is connected to one or more RSUs 112, which can send or receive signals to the traffic light that control the state of the light. In this manner, the VRTS system 100 can determine when and how to change the state of the traffic light. In other embodiments, the traffic light cannot be controlled by the VRTS system 100, which is changed in accordance with a fixed policy or timing, but the state of the traffic light can be transmitted to the vRTSGS instance 102 such that virtualized signs representing the state of the traffic light can be reproduced.

As mentioned above, the CAM notifications carry a rich set of information derived from the TO's on-board sensors and instruments, based on which the vRTSGS instances 102 can derive a situation map 120 capturing the road/traffic/environment situation at the road segments that are covered by the RSUs 112. The situation map 120 can refer to a data structure for representing the road/traffic/environment situation, which can include but is not limited to a multi-map list, as described in more detail below. The vRTSGS instances 102 map the situation map with the road/traffic policy for the respective segment(s) and derives a set of appropriate virtualized road/traffic signs, which are encoded in the DENM notification and disseminated towards the TOs 104 in relevant road segments either as a broadcast and/or unicast message. For example, on-board sensors or instruments can relay information to the vRTSGS instance 102 that indicates the road may be wet (e.g., when windshield wipers are activated, or when antilock brakes have been engaged). Alternatively, instrumentation installed by the road segment (i.e., not in a particular TO 104) may be connected to the RSUs 112 and relay information to the vRTSGS instance 102. The vRTSGS instance 102 can then map the situation map indicating the road is wet to a policy that indicates the speed limit for this segment of road should be reduced in the case of wet pavement. A virtualized speed limit sign indicating the new lower speed limit can be obtained and transmitted to TOs 104 associated with that road segment to indicate the reduced speed limit.

In an embodiment, the DENM notifications are unicast to specific vehicles that require personalized information. For example, a vehicle with engine/mechanical problems, or a slow moving tractor, may require a different speed limit and lane instructions as opposed to regular vehicles. The OBU of each TO 104 will parse the information encoded in the received DENM message and translate them into specific road traffic signs which are then displayed on the display system 130 of the TO 104.

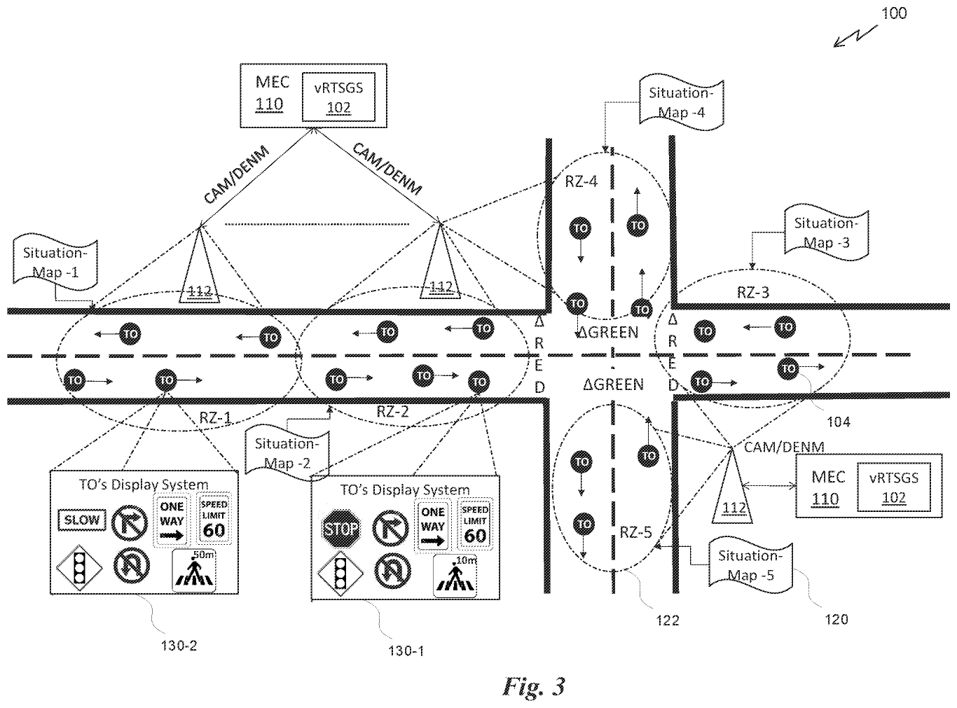

An example of this is illustrated in FIG. 3, which shows the road traffic signs for the two exemplary TOs 104 located at different road segments. For example, the TO 104 near the road junction is instructed to stop with a virtual stop sign and virtual traffic signal icon and an indication of the pedestrian crossing at 10 meters and other symbols appearing on the TOs display system 130, for example, also with appropriate voice commands. Similarly, the TO 104 approaching from behind will have similar road/traffic signs displayed on the display system with the warning to slow down as it approaches the traffic junction with a virtual traffic signal and an indication of an active pedestrian crossing 50 meters ahead appearing on the TOs 104 display system, preferably also with appropriate voice commands. These road/traffic/environment signs are generated based on the information derived by the vRTSGS system and encoded in the DENM messages received by the TOs 104 via the RSUs 112 to which they are connected.

In an embodiment, each MEC system 110 may comprise one or more network devices, such as a server located in a data center that is located at a different location from the RSUs 112 deployed in the field. The MEC system 110 may be connected to the RSUs 112 via a network that can include any combination of wired or wireless networks. For example, the MEC system 110 can communicate with the RSUs 112 via a cellular network, a local area network, a wide area network, the Internet, or any combination thereof. The MEC system 110 can include one or more processors, volatile and/or non-volatile memory, network interface cards, and the like. In some embodiments, the vRTSGS system is a distributed service where each vRTSGS instance 102 is implemented on one of a plurality of server devices located in one or more data centers. In some embodiments, the MEC system 110 can include a gateway device and a plurality of vRTSGS instances 102 such that the variable load due to changing road conditions and varying numbers of TOs 104 can be balanced among a plurality of vRTSGS instances 102.

As mentioned before, the VRTS system 100 develops a situation map (SM) 120 based on the variety of information that it receives from the TOs 104, for example, as information encoded in the periodic CAM notifications. In one embodiment, the VRTS system 100 will construct an SM 120 for each of the different relevance zones (RZs) 122. An RZ 122 represents an area, a geographical zone, or a part of a road segment for which the SM 120 is valid. In other embodiments, an SM 120 can be applied to more than one RZs 122.

In an embodiment, as depicted in FIG. 3, the VRTS system 100 includes five RZs 122, where the RZs 122 are characterized by the coverage footprint of the RSUs 112. There is no limit on the number of RZs 122 or how the RZs 122 are dimensioned. It is assumed that the SM 120 is valid for the respective RZs 122. In this case, the TOs 104 in each RZ 122 will experience and/or are impacted by the situation prevalent in the RZ 122. Also, in some embodiments, there could be more than one SM 120 for a respective RZ 122, where each SM 120 may be valid for traffic in different directions. For example, a road that has a slope may have different SMs 120 corresponding to travel in an uphill direction compared to travel in a downhill direction. The VRTS system 100 will then translate the SM 120 into a situation matrix, which will be correlated with the road/traffic policies that is relevant to the respective RZ 122. As an output of this correlation, the vRTSGS instance 102 will derive a set of virtualized road traffic signs (e.g., signs, messages, and/or instructions) that are encoded in one or more notification messages, e.g., the ETSI ITS DENM notifications, which are then disseminated, via broadcast and/or unicast, to the TOs 104 in the relevant RZs 122.

In an embodiment, each road traffic sign that is derived can be represented as an enumerated data type (enum), where each enum value corresponds to a specific road traffic sign. The enum values are then encoded as a list, referred to herein as an action matrix, in the DENM notification message, which is then broadcasted/unicasted to the TOs 104 in a RZ 122. The OBUs in the TOs 104 shall then decode the enum values in the action matrix into one or more relevant road traffic signs, which are then displayed on the display system 130 in the TO 104, preferably augmented by audio instructions and/or indication lights. In another embodiment, especially in the case of autonomous or semi-autonomous vehicles, some instructions may result in active control of the vehicle. For example, in case of a notification and display of pedestrian crossing sign, the OBU may activate the automatic braking system of the vehicle to ensure it slows down to a stop before the pedestrian crossing that has been virtually identified by the VRTS system 100 and displayed on the vehicle's display system 130.

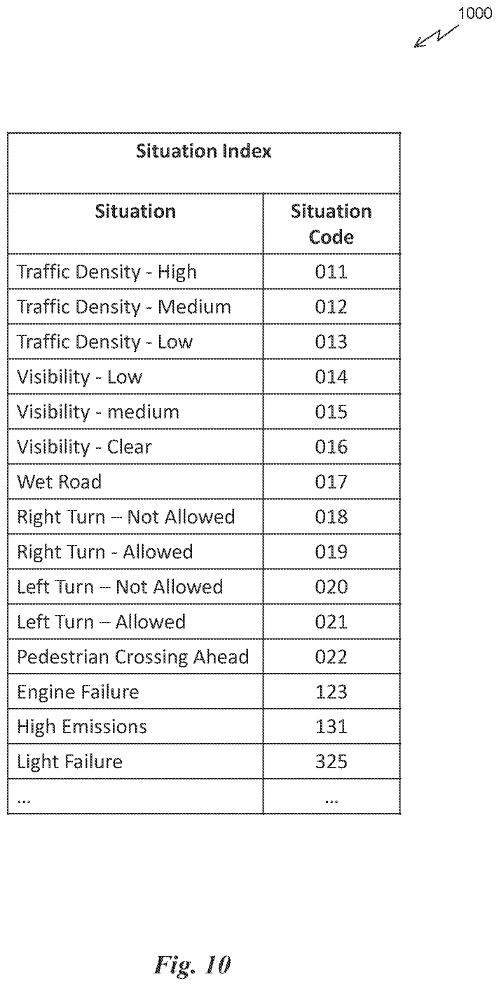

FIG. 10 shows an example of a situation index 1000, according to an embodiment of the present disclosure. A Situation Index (SI) 1000 is a data structure that maintains a non-exhaustive list of road/traffic situations/permissions, and each situation is assigned a unique code, referred to as a situation code. The SI 1000 also contains information that is reflective of the situation local to the TO 104, such as high emission, engine failure, light failure etc. This SI 1000 is maintained by the VRTS system 100 for deriving a situation matrix as will be explained next.

For example, a particular TO 104 may be located in a road segment that is currently experiencing medium traffic density and approaching an intersection where a left turn is not allowed, for example, to alleviate traffic congestion at certain times of day. The SI 1000 for the TO 104 can store a list that includes, but is not limited to, situation codes 012 and 020. The SI 1000 for each TO 104 can be updated periodically (e.g., every second, every 10 seconds, etc.) or asynchronously based on receipt of new notification messages received by the VRTS system 100.

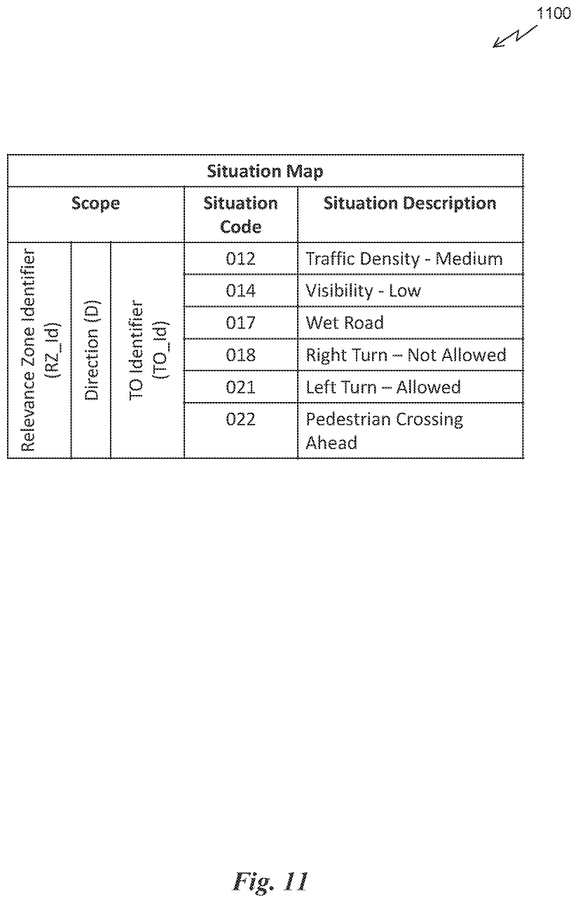

Based on the information encoded in the CAM notifications the VRTS system 100 is receiving periodically from the TOs, it will derive a situation map for the respective RZs 122. FIG. 11 shows an example of a situation map 1100, in accordance with some embodiments. As depicted in FIG. 11, the SM 1100 reflects a situation that is both global and local to the TO 104. In an embodiment, the SM 1100 can be implemented as a multi-map list where the scope of the SM 1100 can be determined by a 3-tuple key identifier, namely the RZ identification (RZ_Id), the Direction (Dir), and the TO Identifier (TO_Id). The RZ_Id can be represented by geo-coordinates to identify or scope the region/zone where for which the SM 1100 is relevant. The Dir indicates the direction of TOs 104 for which the SM 1100 is relevant. As mentioned before, there can be multiple SMs 1100 for the same RZ 122 depending on the direction of the vehicle, the type of vehicle, the local situation of the TO 104 on a particular road segment in the RZ 122, and the like. The TO_Id identifies the specific TO 104 for which this SM 1100 is relevant, in which case the processed information is unicasted to the identified TO 104. In case the TO_Id is all ‘1’s then the information that is processed from this SM is broadcasted to all the TOs 104 in the RZ 122.

Associated with the 3-tuple key of scope is a list of situation code values, where each situation code value represents a particular situation that is global and/or local to the TO 104. For example, code value 012 represents a global situation of medium traffic density in the particular RZ 122, while code value 131 represents a local situation of high emissions for the particular TO 104, and so on. The situation code is constructed by the VRTS system 100 by jointly processing the information encoded in the CAM notifications that it receives from the TOs 104 in the respective RZ 122. The list of situation codes correctly represents the road/traffic/environment situation in the RZ 122.

As a next step, the VRTS system 100 will derive an action matrix by correlating the list of situation codes and the road/traffic policy prescribed for the particular RZ 122. The action matrix is encoded in a notification message, e.g., a ETSI ITS DENM notification message, which is then broadcasted/unicasted in the relevant RZ 122.

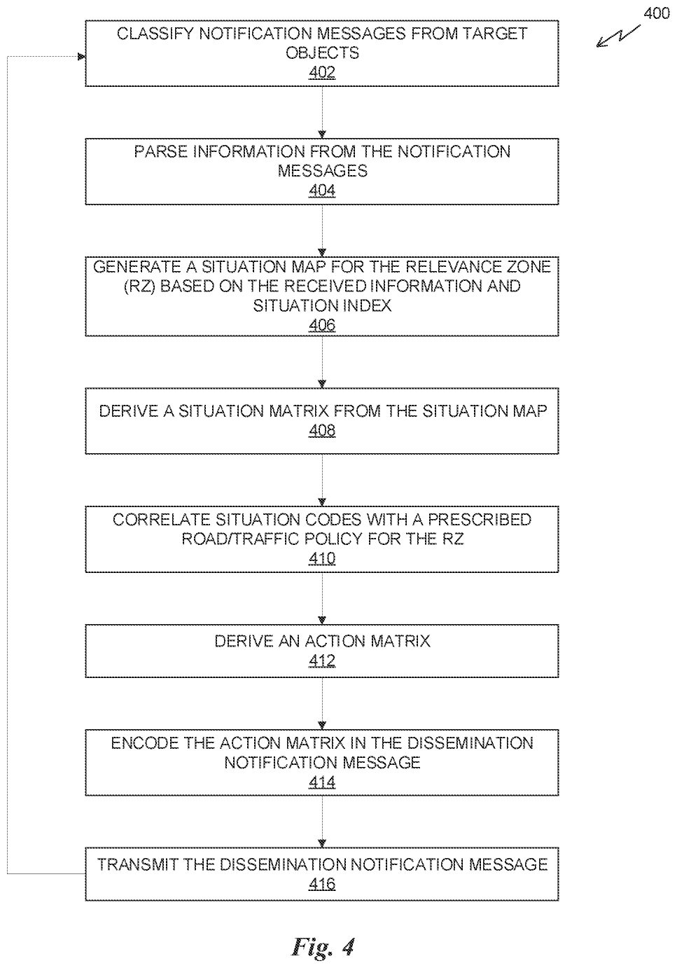

FIG. 4 illustrates a method 400 for creating, disseminating, and removing virtualized road traffic signs, according to an embodiment of the present disclosure. The method 400 is described as being performed by the VRTS system 100 and, more particularly, by the vRTSGS instance 102 executed by one or more MEC systems 110. In some embodiments, the method 400 is embodied as a set of instructions that, responsive to being executed by one or more processors, causes the VRTS system 100 to perform the method 400. It will be appreciated that any system that is configured to perform the method 400 is within the scope of the present disclosure.

The method 400 begins at 402, where information from notification messages is classified by the vRTSGS instance 102. In an embodiment, the MEC system 110 receives one or more CAM messages from the TOs 104, via the RSUs 112. The CAM messages may be classified according to a corresponding RZ 122, such as by mapping a RZ_id to the CAM message based on a TO_id associated with the CAM message. In some embodiments, the vRTSGS instance 102 applies classification rules to the information parsed from the CAM messages. Different classification techniques can be utilized including applying statistical classification algorithms or machine learning algorithms to map the information in the CAM messages to a classification for a situation in a corresponding RZ 122.

At 404, information is parsed from the notification messages. In an embodiment, information may be read from certain fields in the CAM message, which can indicate certain conditions for a particular TO 104, such as a speed of the vehicle, a direction of the vehicle, a state of certain switches or controls in the vehicle (e.g., a state of a headlight switch or a state of the steering wheel).

At 406, an SM 120 is generated for a corresponding RZ 122 based on the receiving information and situation index. In an embodiment, the vRTSGS instance 102 maps information parsed from the CAM message to a situation code listed in the situation index. The situation codes can be added to the SM 120, where the SM 120 has the proper global or local scope. It will be appreciated that the SM 120 can be created as a new data structure or modified according to an existing data structure if an SM 120 of the proper scope already exists in a memory associated with the vRTSGS instance 102.

At 408, a situation matrix is derived from the SM 120. In an embodiment, the situation matrix is a list of situation codes associated with a particular TO 104 located in a particular RZ 122. For example, based on the SM 1100 of FIG. 11, the situation codes in the SM 1100 are used to create a situation matrix as [012, 014, 017, 018, 021, 022, 131]. In an embodiment, the vRTSGS instance 102 can use a map service 106 to determine the type of road (i.e., highway, main road, city road, street road, village road etc.) and the road/traffic policies prescribed by some external entity, such as a public authority, for the particular RZ 122. For example, in case it's a highway the maximum prescribed speed limit can be 120 kmph, with restricted overtaking rules.

At 410, situation codes are correlated with a prescribed road/traffic policy for the RZ 122. In an embodiment, the vRTSGS instance 102 is configured to match situation codes in the SM 120 with various actions prescribed in the road/traffic policy. Within these policy bounds, at 412, an action matrix is derived based on the situation codes correlated with the prescribed road/traffic policy. In an embodiment, the action matrix may be a list of action codes enumerated for various actions. For example, separate and distinct action codes may be assigned to a speed limit of 80 kmph, 90 kmph, 100 kmph, and so forth. In an embodiment, the vRTSGS instance 102 derives the action matrix based on the situation codes and road/traffic policy.

For example, situation code 012 (indicating Traffic density—medium) may result in deriving a reduced speed limit of 100 kmph. However, with additional situation codes like 014 (Visibility—low) and/or 017 (wet road) the vRTSGS instance 102 may derive a further lower speed limit of 80 kmph. It should be noted that the vRTSGS instance 102 may take into account the type of road as well. For example, for the same situation map, but on a city road with a max speed limit of 50 kmph, the vRTSGS instance 102 may derive a speed limit of 30 kmph for all vehicles in that particular RZ 122. Thus, the speed limit is one of the prescribed actions derived by the vRTSGS instance 102. Furthermore, the local situation code may also result in differentiated action, whereby a TO 104 with high emissions (e.g., situation code value 131) may be restricted from entering green zones.

At 414, the action matrix is encoded in a dissemination notification message. In an embodiment, the vRTSGS instance 102 generates a DENM notification message based on the action matrix. In other words, the action codes in the action matrix may be encoded within a body of the DENM notification message.

At 416, the dissemination notification message is transmitted to the RZ 122. In an embodiment, the DENM message is broadcast or unicast to the RZ 122 by transmitting the DENM message to a corresponding RSU 112.

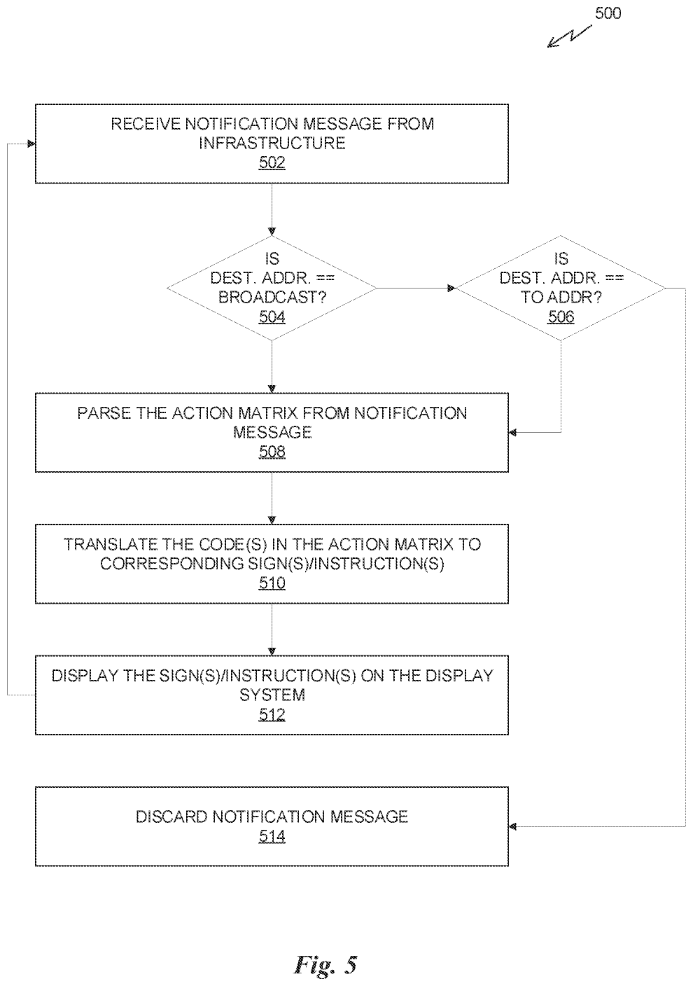

FIG. 5 illustrates a method 500 for receiving and displaying virtualized road traffic signs, according to an embodiment of the present disclosure. The method 500 is described as being performed by a TO 104 and, more particularly, by the OBU of a TO 104. In some embodiments, the method 500 is embodied as a set of instructions that, responsive to being executed by one or more processors of the OBU, causes the TO 104 to perform the method 500. It will be appreciated that any system that is configured to perform the method 500 is within the scope of the present disclosure.

The method 500 begins at 502, where the TO 104 receives a notification message from the VRTS system 100. In an embodiment, the TO 104 establishes a communication channel with one or more RSUs 112 within range of the TO 104. Once the communication channel is established, the TO 104 can send CAM messages to the VRTS system 100 via the RSUs 112 and receive DENM notification messages from the VRTS system 100.

At 504, the OBU determines whether the destination address in the notification message is a broadcast address. For example, in an embodiment, the OBU can parse the destination address from the notification message and compare the destination address to a broadcast address. In an embodiment, the broadcast address is an IP address that is assigned as a broadcast channel to be received by any TO 104 in a particular network. Responsive to determining that the destination address is a broadcast address, the method can proceed to 508, where the action matrix is parsed from the notification message. In an embodiment, the action matrix is encoded within a body of the DENM message. In other embodiments, action codes can be encoded in various fields within the body of the notification message.

Returning to 504, responsive to determining that the destination address is not a broadcast address, at 506, the OBU determines whether the destination address in the notification message is a unicast address associated with that TO 104. For example, in an embodiment, the OBU can parse the destination address from the notification message and compare the destination address to a unicast address for the TO 104. In an embodiment, when the TO 104 establishes a communication channel with the RSU 112, the OBU is assigned an network address (e.g., an IP address). Thus, if the destination address matches the IP address of the OBU, then the method 500 proceeds to 508. Otherwise, responsive to determining that the destination address is neither the broadcast address nor a unicast address associated with that TO 104, at step 514, the notification message is discarded.

Returning to 510, after the action matrix is parsed from the notification message, the OBU translates the action codes from the action matrix into virtual traffic sign(s)/instruction(s). In an embodiment, each action code corresponds to a particular instance of a relevant road/traffic/environmental sign/message, which may be stored in a memory associated with the OBU. For example, the virtualized road/traffic sign can be an image for display on the display system 130 (e.g., an LED or OLED display device) of the TO 104. For this purpose the TO 104 shall maintain an action index that maps the action codes with the road/traffic/environmental signs/messages. Alternatively, the action code can correspond to a set of instructions for selecting a particular instance of a virtualized road/traffic sign or causing a particular expression of the road/traffic sign to be displayed. For example, the action code can correspond to instructions that cause the OBU to change the state of a switch for a light that indicates the vehicle should come to a stop (i.e., a red light in the passenger compartment of a vehicle is illuminated). In another embodiment, the action code can correspond to a character string (i.e., information, a warning, or the like) that is displayed on the display system 130.

At 512, the road/traffic signs/information is then displayed on the display/notification system 130 of the TO 104. In some embodiments, the display can be additionally augmented by voice/sound indications.

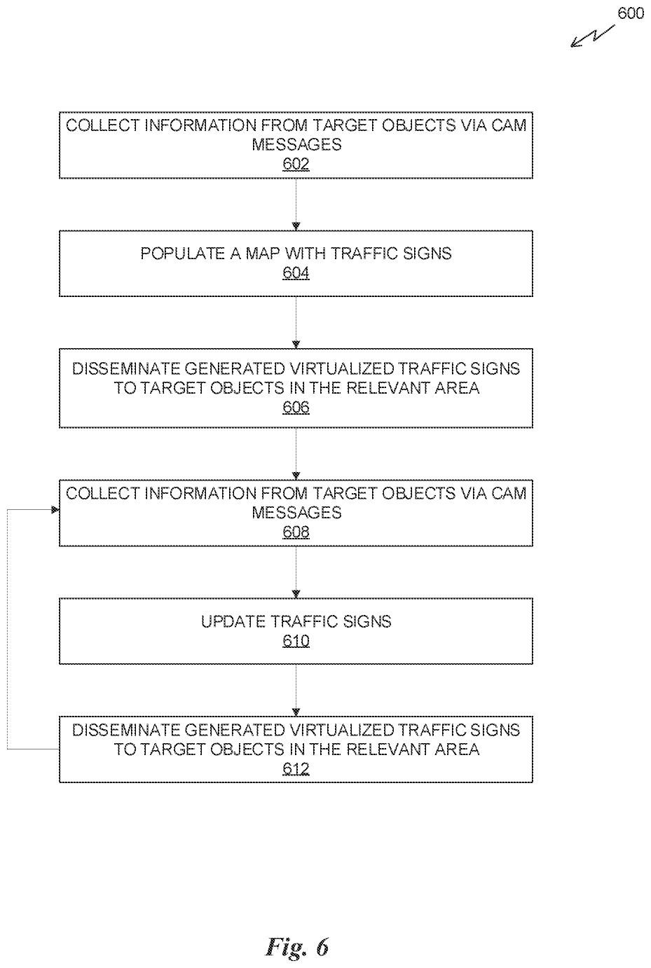

FIG. 6 illustrates a method 600 for generating a situation map and deriving an action-matrix for a notification message, according to an embodiment of the present disclosure. The method 600 is described as being performed by the VRTS system 100 and, more particularly, by the vRTSGS instance 102 executed by one or more MEC systems 110. In some embodiments, the method 600 is embodied as a set of instructions that, responsive to being executed by one or more processors, causes the VRTS system 100 to perform the method 600. It will be appreciated that any system that is configured to perform the method 600 is within the scope of the present disclosure.

The method 600 begins at 602, where information is collected from TOs 104 via CAM messages. Again, TOs 104 can report various data collected by sensors or instruments included in the TOs 104. The information from the TOs 104 can also be supplemented with additional information from separate sensors or instruments as well as information from other sources such as a map service and/or a weather service, for example.

At 604, a map is populated with virtualized traffic signs. In an embodiment, the map is a data structure that associates virtualized traffic signs with one or more RZs 122. For example, the map can comprise a map or a multimap data structure that associates a key (e.g., a RZ_id) to an identifier for a virtualized traffic sign. In other words, the map can comprise a key-value pair that maps an RZ 122 to one or more virtualized traffic signs associated with that RZ 122. The map data structure can contain a plurality of key-value pairs corresponding to a plurality of RZs 122 and/or a plurality of different virtualized traffic signs associated with a single RZ 122.

At 606, virtualized traffic signs are disseminated to TOs 104 in a RZ 122. In an embodiment, the virtualized traffic signs associated with a particular RZ 122 are collected to generate an action matrix, which is encoded in a DENM notification message that is transmitted via broadcast or unicast to one or more TOs 104 in the RZ 122.

At 608, new information is collected from TOs 104 via CAM messages. In an embodiment, the vRTSGS instance 102 continues to receive CAM messages periodically from the TOs 104. The vRTSGS instance 102 can analyze the CAM messages to determine whether any information contained therein is substantially different from the information that was collected earlier. In an embodiment, the information parsed from the CAM messages can be compared to the situation codes in a particular SM 120 for a corresponding RZ 122. If the situation code is already included in the SM 120, then the CAM message can be discarded. Otherwise, the CAM message is forwarded for further processing to update the SM 120.

At 610, the map is updated. In one embodiment, one or more virtualized traffic signs are added to the map, deleted from the map, or moved within the map. In an embodiment, the vRTSGS instance 102 is configured to match situation codes in the updated SM 120 with various actions prescribed in a road/traffic policy. An action matrix is derived based on the situation codes correlated with the prescribed road/traffic policy, and the action matrix may be compared with the virtualized traffic signs associated with a particular RZ 122 of the map to determine whether any of the virtualized traffic signs need to be updated.

At 612, virtualized traffic signs are disseminated to TOs 104 in a relevant RZ 122. The vRTSGS instance 102, responsive to updating the map, can trigger new DENM notification messages to be sent to the TOs 104.

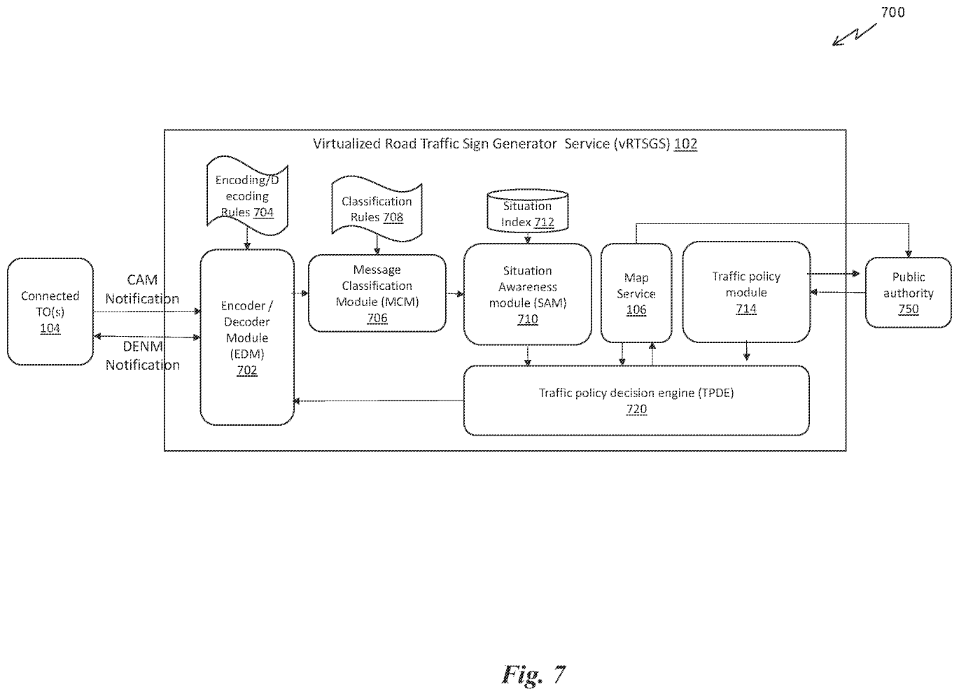

FIG. 7 schematically illustrates a functional architecture of a virtualized road traffic signs generator service (vRTSGS) instance 102, according to an embodiment of the present disclosure. A system 700 includes the vRTSGS instance 102 in communication with one or more TOs 104 and, optionally, a public authority system 750. As depicted in FIG. 7, the vRTSGS instance 102 includes an encode/decoder module (EDM) 702, a message classification module (MCM) 706, a situation awareness module 710, a map service 106, a traffic policy module 714, and a traffic policy decision engine 720. As used herein, a module or engine can refer to a software program executed by one or more processors. The software program can include a set of instructions, each instruction executed by at least one of the processors, stored on a computer-readable medium such as a memory communicatively coupled to the processors. Furthermore, the vRTSGS instance 102 refers to a particular instantiation of a service on a server device. As a distributed cloud service, many vRTSGS instances 102 can be deployed in one or more data centers simultaneously.

Encode/Decoder Module (EDM): The EDM 702 is responsible for the decoding of information relevant to vRTSGS instance 102 from the incoming notification messages from the connected TOs 104. The EDM 702 is also responsible for the encoding of the action matrix relevant to RZ(s) 122 and other relevant information in the notification messages that is to be disseminated by the vRTSGS instance 102 towards the TOs 104 in the RZ(s) 122 in a format suitable for the vRTSGS clients (e.g., the OBU of the TO 104). In case of ETSI CAM/DENM notifications, the EDM 702 shall include the ITS protocol stack. In an embodiment, the EDM 702 encodes/decodes based on the rules specified in the encoding/decoding rules 704. For example, the encoding/decoding rules 704 may specify the structure of the CAM/DENM notifications that enable the EDM 702 to parse out the targeted information needed to classify the situation in a particular RZ 122.

Message Classification Module (MCM): The MCM 706 is responsible for determining whether the decoded information has changes that needs to be forwarded to the situation awareness module (SAM) 710. In case the decoded information content/context has not changed noticeably, the decoded information will not be forwarded to SAM 710 for processing. In other words, the MCM 706 is responsible for managing the processing load of the vRTSGS instance 102 by only forwarding messages of interest, and responsive to determining that the relevant parameters in the received notification messages have varied noticeably. In an embodiment, the MCM 706 classifies messages/information based on specified classification rules 708.

In some embodiments, classification rules can be enforced by the MCM 706. For example, one classification rule can be based on relevance or repetitiveness of messages that causes the MCM 706 to discard messages responsive to determining that the information in the message matches the current status of the RZ 122. Thus, the MCM 706 only forwards relevant information to effect RZ 122 status updates. Another classification rule can be based on the frequency of message forwarding. For example, in crowded scenarios, many messages from a large number of TOs can be delivered that contain similar information. In such cases, the classification rule specifies that only a subset of the messages should be processed (e.g., randomly based on time stamps associated with the messages or dynamically based on other characteristics, such as TO identifiers or number of messages sent from a particular TO). Yet another example provides a classification rule related to outlier detection. For example, if a TO sensor is faulty and the corresponding messages contain corrupted data that strongly mismatches the overall information sent from other TOs, such messages could be discarded.

In some embodiments, classification rules can be applied using various techniques, such as simple binary comparisons and/or advanced machine learning techniques. In some embodiments, two or more rules can be applied to a single message by processing the rules sequentially. For example, a forward/discard decision can be made based on frequency and relevance.

In an embodiment, a rule in classification rules 708 may specify a threshold related to a sensor value that triggers a different classification of the situation in a RZ 122. For example, the rule may specify a threshold related to visibility reduction caused by the presence of fog. A sensor may measure visibility by any suitable means and, if the visibility is identified as being below the threshold, the situation may be classified as “reduced visibility.” A notification about the change in classification for a particular RZ 122 may be sent to the situation awareness module.

Situation Awareness Module (SAM): The SAM 710 is at the heart of the vRTSGS instance 102 where it is able to process the information received from the MCM 706 for generating the Situation Map 120 for RZ(s) 122 with the help of Situation Index 1100 and deriving a situation matrix, as described before. The SAM 710 is able to monitor and track the traffic situation based on the information received and may also utilize prediction functions in order to predict road/traffic situation to forewarn TOs 104 of any impending dangerous situation. For the traffic prediction task federated learning techniques can be adopted to exploit the knowledge available from neighboring MEC/Edge Servers 110.

Map Service: The map service 106 provides the SM 120 to a public authority system 750 to provide a public authority with an overall view of the RZs 122. Sharing the SM 120 generated by the vRTSGS instance 102 allows the public authority to improve a current traffic policy and/or enforce extraordinary policies in case of emergency or other unique circumstance. The map service 106 may also communicate the SM 120 with a Traffic Policy Decision Engine. In an embodiment, the map service 106 is included as a module within the vRTSGS instance 102. In other embodiments, the map service 106 is a separate service that communicates directly with the vRTSGS instance 102 and is permitted access to the SM 120.

Traffic Policy Decision Engine (TPDE): The TPDE 720 is responsible for correlating the situation-codes in the situation-matrix with each other and the road/traffic policy that is prescribed for the road segment in the respective RZ(s). Based on this correlation, the TPDE derives an action-matrix, which is then outputted to the EDM function for encoding it in the notification messages towards the TOs in the RZ. As stated before, the TPDE may derive different action-matrix for different RZs with similar situation-matrix depending on the traffic policy.

Traffic policy module (TPM): The TPM 714 is in charge of storing information on the traffic policy applicable in the area covered by the VRTS system 100, such as speed limits, priority signs, parking, one-way streets etc. The content of the module can be adapted to the different regulations in force in different locations; thus, the TPM 714 can adapt to regulations of different countries, and local authorities can interact with this module to enforce new or modify existing traffic regulations. The TPM 714 furnishes road/traffic policies/rules (e.g., speed limits, warnings, restrictions, etc.) that are prescribed for road segments by an external public authority 750. This policy is used by the TPDE 720 as bounds when deriving the action matrix as part of the correlation process. In an embodiment, the TPM 714 may also communicate with the public authority 750 to ensure synchronicity with the policies prescribed by the public authority.

In some embodiments, the vRTSGS instance 102 can be realized as a virtual function or a container function and instantiated over a NFV (Network Functions Virtualization) infrastructure, the lifecycle of which can be managed by the management and orchestration (MANO) system. The individual functional modules comprising the vRTSGS instance 102 can be realized as micro-functions, which are then interconnected over virtual links to create the VRTS service.

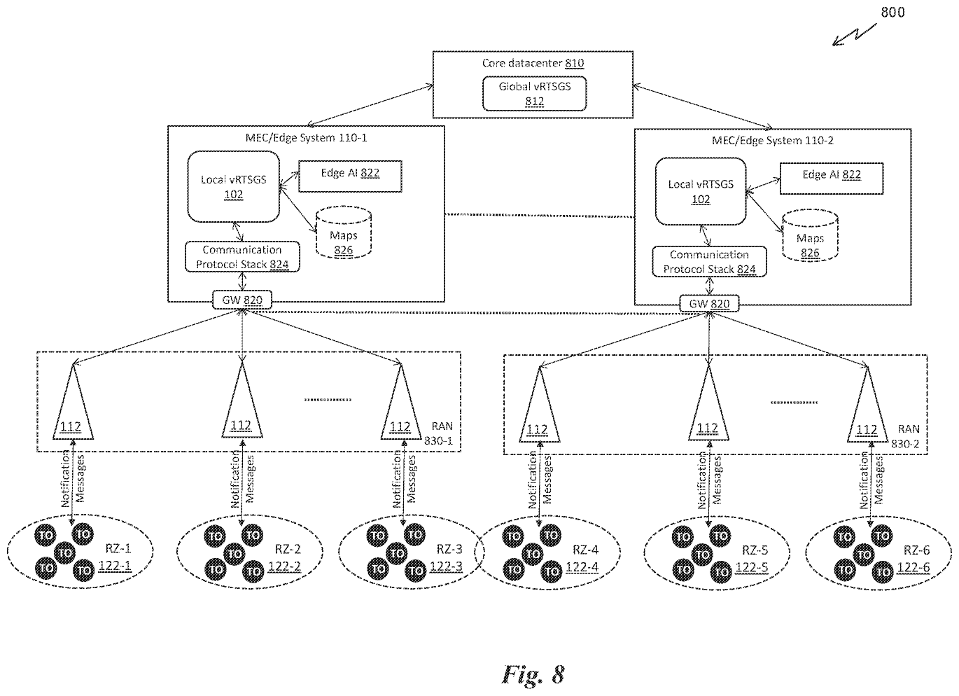

FIG. 8 schematically illustrates a method and system architecture of a distributed virtualized road traffic signs generator service, according to an embodiment of the present disclosure. As depicted in FIG. 8, the system architecture is implemented by a network 800 that includes a core datacenter 810 and a number of MEC/Edge systems 110, including at least a first MEC system 110-1 and a second MEC system 110-2. The core datacenter 810 can include a number of computing and/or storage resources, such as server devices, storage area networks, and network switches or routers, physically arranged in a central location. The core datacenter 810 can include various functionality implemented therein that are available throughout the network 800.

Each MEC system 110 can be connected to a radio access network (RAN) 830 via a gateway 820. The RAN 830 includes one or more RSUs 112, which can be a base station (e.g., NodeB, eNodeB, etc.), WiFi Access Point (AP), or the like. Each RSU 112 can correspond with one or more RZs 122 including zero or more TOs 104. As shown in FIG. 8, a first RAN 830-1 includes at least three RSUs 112 corresponding to a first RZ 122-1, a second RZ 122-2, and a third RZ 122-3. A second RAN 830-2 includes at least three additional RSUs 112 corresponding to a fourth RZ 122-4, a fifth RZ 122-5, and a sixth RZ 122-6.

TOs 104 in each RZ 122 communicate with a corresponding GW 820 by transmission and reception of CAM/DENM notification messages through a corresponding RSU 112. It will be appreciated that each RAN 830 can be configured to communicate with a different GW 820 corresponding to one of the MEC systems 110.

In an embodiment, the core datacenter 810 includes a global vRTSGS module 812 that is configured to communicate with a number of local vRTSGS instances 102 implemented on the various MEC systems 110. The global vRTSGS module 812 can facilitate sharing of information between the various distributed local vRTSGS instances 102, monitor load at each local vRTSGS instance 102, and instantiate new vRTSGS instances 102 or close idle vRTSGS instances 102. In some embodiments, the global vRTSGS module 812 can enforce changes to the SM 120 at a regional or county level while local vRTSGS instances 102 enforce changes to the SM 120 valid for a specific subset of RZs 122. For example, a policy change at the global vRTSGS module 812 can be applied to each local SM 120 by pushing the change to each local vRTSGS instance 102, but a change to a SM 120 at the local vRTSGS instance 102 will not be propagated to other local vRTSGS instances 102.

In an embodiment, the MEC system 110 includes the local vRTSGS instance 102 as well as an EDGE AI module 822, a communication protocol stack 824, and a maps database 826. The EDGE AI module 822 can store various programs to implement machine learning algorithms. In some embodiments, the EDGE AI module 822 can be implemented by one or more processors including a host processor and at least one parallel processor or other special function processor configured to accelerate machine learning algorithms. For example, the EDGE AI module 822 can store instructions for implementing a neural network that is trained to process situation maps 120 and policies to determine an optimal set of action codes for a given RZ 122. The local vRTSGS 102 can then utilize the neural network to derive the action codes based on the situation map 120.

The communication protocol stack 824 can be any protocol stack for communicating with the TOs 104 via the RAN 830. In an embodiment, the communication protocol stack 824 can be a TCP/IP stack used to communicate with the TOs 104 via a wireless local area network. In other embodiments, the communication protocol stack 824 can be a protocol stack for communicating via a cellular network. In one embodiment, the communications protocol stack can be that of a 3GPP based Evolved Packet Core (EPC) over which an ETSI C-ITS protocol application is used for CAM/DENM message processing (e.g., encoding/decoding and parsing).

The maps storage 826 is a non-volatile memory for storing situation maps 120 for the various RZs 122 managed by the MEC system 110. The non-volatile memory can include hard disk drives (HDD), solid state drives (SSD), flash memory, or the like. In some embodiments, the maps storage 826 can include volatile memory, in addition to or in lieu of the non-volatile memory, such as dynamic random access memory (DRAM) coupled to a processor or included in a package of an integrated circuit (IC) or system on a chip (SoC).

In some embodiments, the vRTSGS instance 102 can be instantiated in different MEC systems 110. In order to create a collaborative environment with extended coverage, the vRTSGS instances 102 in different edge/MEC systems 110 collaborate with the other vRTSGS instances 102 by peering with each other. Collaboration among different peer instances can be employed to distribute local traffic information among peers and improve the effectiveness of generated virtual signs. For example, TOs 104 on one or more RZ 122 that is covered by one MEC system 110 could be slowed down in advance when approaching a congested RZ 122 under the administration of another MEC system 110. The peering vRTSGS instances 102 in different MEC systems 110 will exchange with each other the situation matrix and the action matrix that they have derived for the RZ(s) 122 under their respective administrative domain. This will enable the vRTSGS instances 102 to become aware of the prevalent road/traffic/environmental situation of the neighboring RZ(s) 122 that is under a different MEC domain. In this way, the vRTSGS instance 102 can derive an action matrix that may preempt TOs 104 in its RZ(s) 122 with actions that may help the situation in the next RZs 122. For example, in a case of congestion in the subsequent RZ 122, the vRTSGS instance 102 may prescribe a lower speed limit for TOs 104 in its RZ 122 that may be moving into the congested RZ 122 so that congestion situation is not exacerbated.

According to FIG. 8, the two MEC systems 110 in different administrative domains are able to provision the vRTSGS instances 102 to multiple RZs 122. For the sake of explanation, in some embodiments, the coverage area of each mobile network Base Station (BS) characterizes a RZ 122. Thus MEC system 110-1 services RZ-1 to RZ-3 while MEC system 110-2 services RZ-4-RZ-6. The TOs 104 and the vRTSGS instance 102 in each respective RZ 122 will exchange notification messages (e.g., ETSI ITS CAM/DENM notifications) with each other via the mobile network infrastructure which is connected to the MEC systems 110 via a GW 820 (e.g., PGW or SGW in case of a EPC network, or via N6 interface with a 5G network core). The vRTSGS instances 102, which are deployed in the two MEC systems 110, can either Inter-coordinate with each other directly over a first interface. With reference to the standard ETSI MEC architecture, the first interface can be realized with the Mp3 interface. Another option is to enable a global vRTSGS module 812 in a 5G Core or data center 810, that will ensure inter-coordination between the two vRTSGS instances 102 in the two MEC systems 110. In such a case, the vRTSGS instances 102 shall communicate with the global vRTSGS module 812 via a second interface. The global vRTSGS module 812 shall coordinate the state transfer between the distributed vRTSGS instance 102, or it can act alone as a single vRTSGS instance 102 for all the RZs 122.

Another embodiment, although not shown, is to exploit the V2V communication in order to propagate the action codes received by one or more TOs to other TOs within communication range that might not be connected to the VRTS system 100.

It should be noted that the TOs 104 can be either a vehicle or a mobile phone carried by a pedestrian. In case of pedestrians, the VRTS system 100 can indicate to the pedestrians via the mobile phone when or where to cross the road within the vicinity of their current location. Based on the notification messages received from the TOs, the VRTS system 100 can create crowd/traffic maps that can further be used as an input towards deriving an action matrix, as described above.

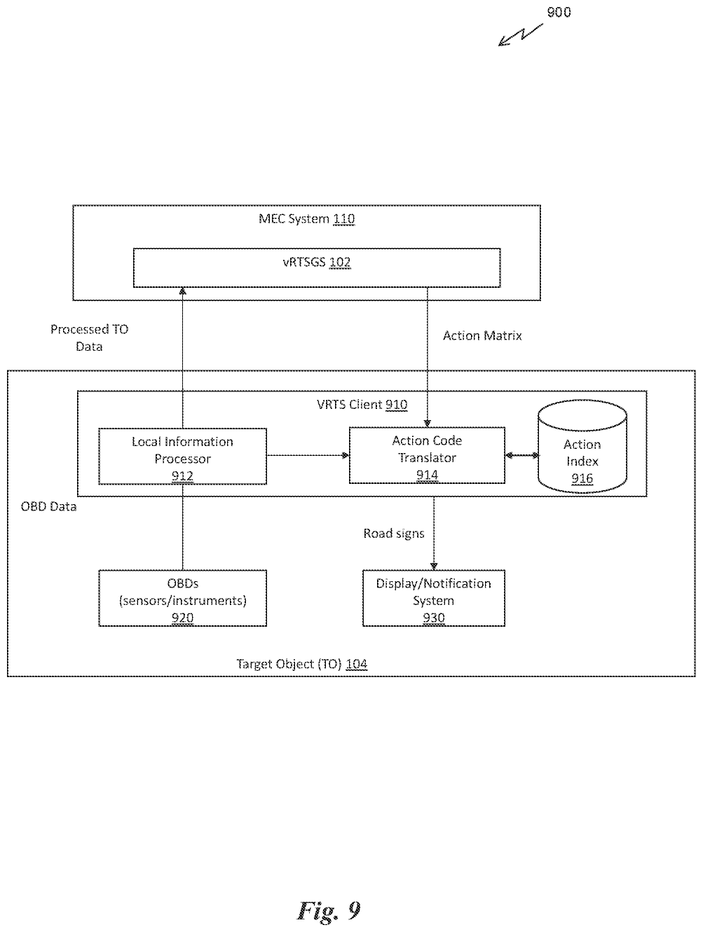

FIG. 9 schematically illustrates interactions between a client and server according to an embodiment of the present disclosure. FIG. 9 shows the interaction between the vRTSGS instance 102 (i.e., the VRTS service) and the VRTS Client 910 in the TO 104. The details of the vRTSGS instance 102 is described above with reference to FIG. 7. The Local Information Processor module 912 in the VRTS Client 910 in the TO 104 collects and processes information received from the TO's on-board devices (OBDs) 920, such as sensors and instruments. This information is periodically sent by the VRTS Client 910 to the vRTSGS instance 102 that is instantiated on the nearest MEC system 110. This information, together with the information collected from the other TOs 104 and also from peering vRTSGS instances 102 instantiated in other federated MEC systems 110, is processed by the vRSTGS instance 102 to derive an action matrix, as described above. The action matrix, containing action codes, is then disseminated via broadcast and/or unicast to VRTS clients in the TOs 104 in the respective RZs 122. The Action Code Translator 914 maps the received action codes to the Action Index 816, which may be a data store (e.g., non-volatile and/or volatile memory), to translate the action codes into representative road/traffic/environment signs/information/warnings, which is then sent to the TO's display/notification system 930.

While embodiments of the present disclosure have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below.

Additionally, statements made herein characterizing the invention may refer to an embodiment of the invention and not necessarily all embodiments.

It is noted that the techniques described herein may be embodied in executable instructions stored in a non-transitory computer-readable medium for use by or in connection with a processor, system, apparatus, or device. It will be appreciated by those skilled in the art that, for some embodiments, various types of computer-readable media can be included for storing data. As used herein, a computer-readable medium may refer to any suitable media for storing the executable instructions of a computer program such that the processor, system, apparatus, or device may read the instructions from the computer-readable medium and execute the instructions for carrying out the described embodiments. Suitable storage formats include one or more of an electronic, magnetic, optical, and electromagnetic format. A non-exhaustive list of conventional exemplary computer-readable media includes: a portable computer diskette; a random-access memory (RAM); a read-only memory (ROM); an erasable programmable read only memory (EPROM); a flash memory device; a hard disk drive (HDD), a solid state drive (SSD), and optical storage devices, including a portable compact disc (CD), a portable digital video disc (DVD), and the like.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for generating information for display in a target object (TO) located in a relevance zone (RZ), the method comprising:
receiving at least one first notification message from one or more TOs;
generating a situation map for the RZ based on information in the at least one first notification message;
encoding an action matrix in a second notification message, wherein the action matrix is derived based on the situation map; and
transmitting the second notification message to the TO in the RZ.

2. The method of claim 1, wherein the at least one first notification message received from the one or more TOs comprises a Cooperative Intelligent Transport System (C-ITS) Cooperative Awareness Message (CAM) message.

3. The method of claim 2, wherein each target object comprises an on-board unit (OBU) of a vehicle, wherein the OBU is configured to establish a wireless communication channel with a road side unit (RSU), and wherein the RSU comprises a base station or an access point for a wireless network.

4. The method of claim 1, wherein the RZ is associated with one or more situation maps of varying scope, and wherein the scope of a particular situation map is encoded in a 3-tuple key identifier that includes a RZ identification (RZ_Id), a Direction (Dir), and a TO Identifier (TO_Id).

5. The method of claim 1, wherein encoding the action matrix in the second notification message comprises:
deriving a situation matrix based on the situation map;
correlating situation codes in the situation matrix with a policy for the RZ;
deriving an action matrix based on the situation codes correlated with the policy; and
encoding the action codes in the action matrix in the second notification message.

6. The method of claim 5, wherein the second notification message comprises a C-ITS Decentralized Environmental Notification Message (DENM) notification message.

7. The method of claim 1, wherein the information included in the at least one first notification message comprises at least one of:
a type of a particular TO;
a position of the particular TO;
a speed of the particular TO; or
a direction of the particular TO.

8. A method for displaying information in a target object (TO), the method comprising:
transmitting at least one first notification message to a service, wherein the notification message includes information related to the TO;
receiving a second notification message from the service;
parsing an action matrix from the second notification message;
translating action codes included in the action matrix into display information; and
presenting the display information on a display device of the TO.

9. The method of claim 8, wherein prior to parsing the action matrix from the second notification message from the service, the method further comprises:
determining that a destination address included in the second notification message is a broadcast address or a unicast address associated with the TO, and
parsing the action matrix from the second notification message from the service; or
determining that the destination address is a unicast address that is not associated with the TO, and
discarding the second notification message from the service.

10. The method of claim 8, wherein the information included in the at least one first notification message comprises at least one of:
a type of the TO;
a position of the TO;
a speed of the TO; or
a direction of the TO.

11. The method of claim 8, wherein the display information comprises an image of a virtualized road/traffic sign and presenting the display information on the display device of the TO comprises displaying the image on a light emitting diode (LED) or organic light emitting diode (OLED) display device of the TO.

12. The method of claim 8, wherein the display information comprises a character string and presenting the display information on the display device of the TO comprises displaying the character string on a light emitting diode (LED) or organic light emitting diode (OLED) display device of the TO.

13. A mobile edge computing (MEC) system for generating and displaying information in a target object (TO) located in a relevance zone (RZ), the MEC system comprising:
one or more processors configured to implement a service that causes the one or more processors to:
receive at least one first notification message from one or more TOs,
generate a situation map for the RZ based on information in the at least one first notification message,
encode an action matrix in a second notification message, wherein the action matrix is derived based on the situation map, and
transmit the second notification message to TO in the RZ.

14. The system of claim 13, wherein encoding the action matrix in the second notification message comprises:
deriving a situation matrix based on the situation map;
correlating situation codes in the situation matrix with a policy for the RZ;
deriving an action matrix based on the situation codes correlated with the policy; and
encoding the action codes in the action matrix in the second notification message.

15. A system for generating and displaying information in a target object (TO), the system comprising:
one or more road side units (RSUs) configured to establish a wireless communication channel with one or more TOs; and
the mobile edge computing (MEC) system of claim 13.
